(19) United States
(12) Patent Application Publication
(10) Pub. No.: US 2010/0129177 A1
(43) Pub. Date: May 27, 2010

(54) CONNECTING MEMBER

(75) Inventor: BIN DAI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/494,545

(22) Filed: Jun. 30, 2009

(30) Foreign Application Priority Data
Nov. 21, 2008 (CN) 200810305691.0

(51) Int. Cl. F16B 37/00

(52) U.S. Cl. 411/427

(57) ABSTRACT

A connecting member includes an elongated body portion. The body portion defines a hole. A sidewall of the hole defines a plurality of slots communicating the hole. A plurality of supporting portions are formed between adjacent slots. At least one slot is above or below each supporting portion along a longitudinal axis of the body portion.

### BACKGROUND

1. Technical Field

The present disclosure relates to a connecting member.

2. Description of the Related Art

A means to connect two parts generally includes, for example, welding, surrounding fastener locking, and riveting the two parts together.

Generally, a typical connecting member, such as a surrounding fastener or a rivet includes a head portion and a body portion extending therefrom. A length of the body portion is substantially constant. Therefore, it is difficult to fix a first part on a second part tightly by two or more connecting members with a constant length because thicknesses from the first part to the second part on different points may be different. Furthermore, the use of different connecting members increases manufacturing costs.

Therefore, a new connecting member is desirable in order to overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts through the several views.

FIG. 1 is an isometric view of a first embodiment of a connecting member.

FIG. 2 is similar to FIG. 1, but viewed from another aspect.

FIG. 3 is a cross-section of the connecting member taken along line III-III in FIG. 2.

FIG. 4 is a cross-section of the connecting member in FIG. 3 prior to being fully received in a part.

FIG. 5 is a cross-section of the connecting member after being received in the part shown in FIG. 4.

FIG. 6 is a cross-section of a second embodiment of a connecting member.

### DETAILED DESCRIPTION

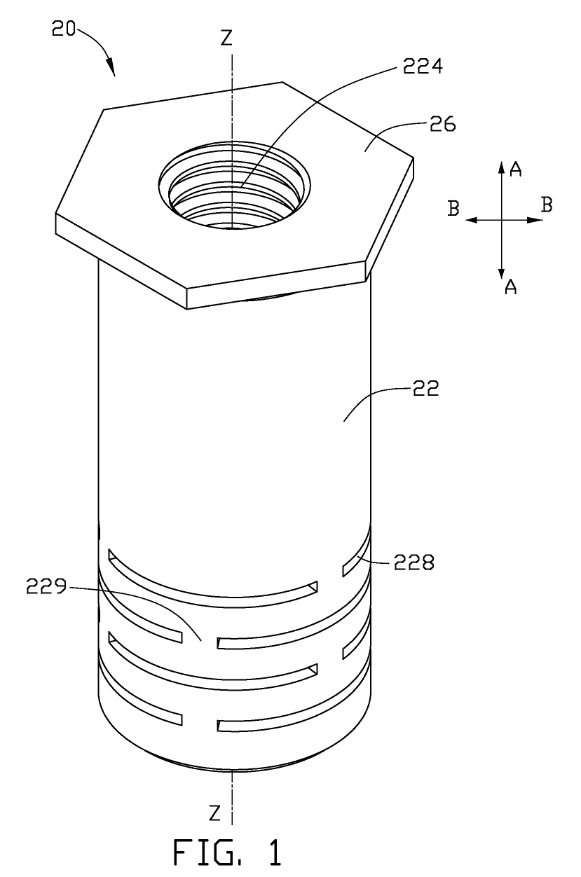

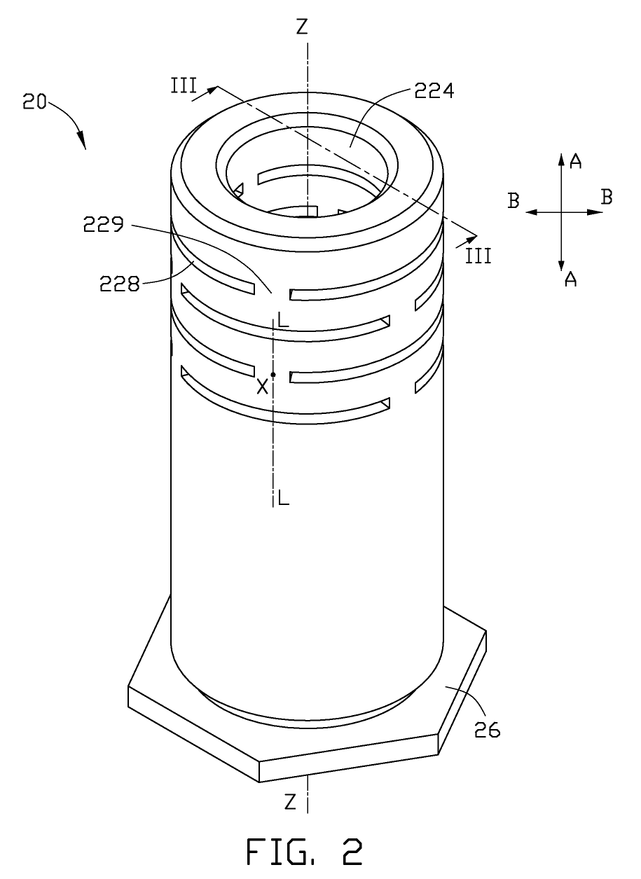

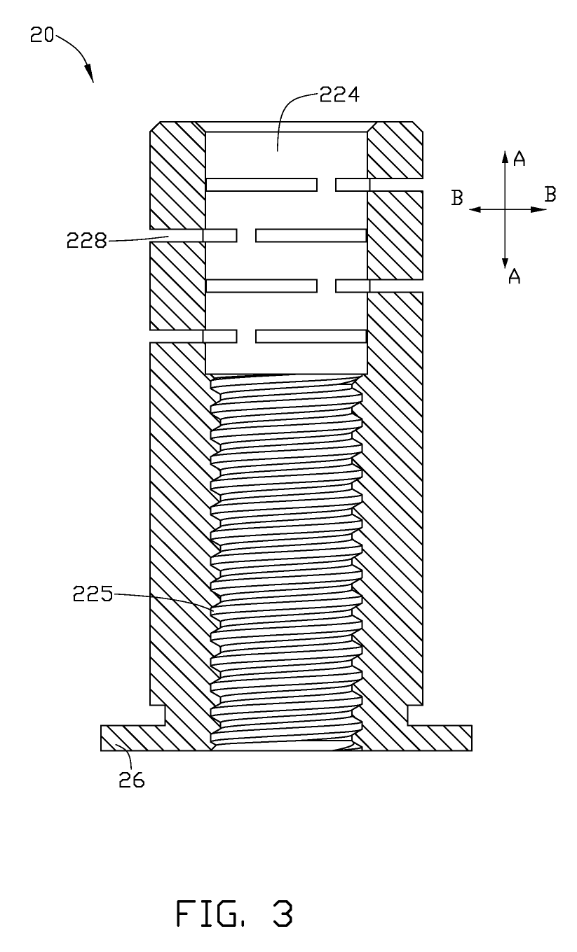

Referring to FIGS. 1 through 3, a first embodiment of a connecting member 20 is shown. The connecting member 20 may be a rivet, and includes a body portion 22 and a head portion 26 formed on an end of the body portion 22. The head portion 26 may be substantially hexagonal.

The body portion 22 may be substantially cylindrical. The body portion 22 defines a hole 224 substantially extending along a central axis Z-Z of the body portion 22 and a plurality of slots 228 in a sidewall of the hole 224. A plurality of supporting portions 229 are formed as a result of the slots 228. Adjacent slots 228 are separated by one corresponding supporting portion 229. A line L-L parallel to the central axis Z-Z and passing a point X located along any one supporting portion 229 crosses at least one slot 228. In other words, at least one slot 228 is above or below each supporting portion 229 along the longitudinal axis A-A of the body portion 22.

In the illustrated embodiment, the slots 228 are curved, and a center of an arc defined by each slot 228 substantially coincides with the central axis Z-Z of the body portion 22. The slots 228 may extend substantially perpendicularly to the longitudinal axis A-A of the body portion 22. In the illustrated embodiment, each three adjacent slots 228 in a lateral axis B-B may be distributed in the body portion 22 evenly along a same circumference. However, there may be one, two, or more than three adjacent slots 228 distributed in the body portion 22 along the same circumference.

The body portion 22 defines a plurality of threads 225 extending partially in an inner surface of the hole 224. The threads 225 may be adjacent to the head portion 26.

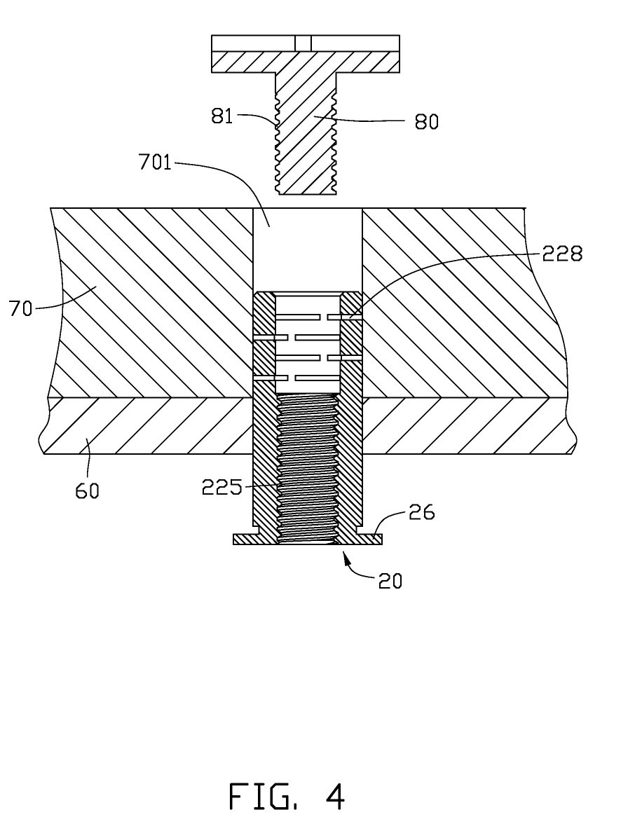

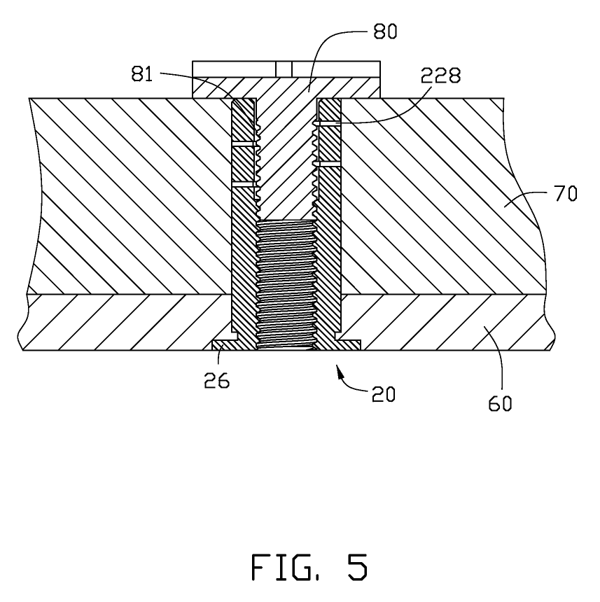

Also referring to FIGS. 4 and 5, in use, the body portion 22 is received in a hole (not labeled) of a first part 60 and a hole 701 of a second part 70. Then the head portion 26 is subjected to an external force so as to be embedded into the first part 60 (shown in FIG. 5). Finally, a surrounding fastener 80 is inserted into the hole 224 in such manner that threads 81 of the surrounding fastener 80 engage with the threads 225 of the connecting member 20, thereby fixing the second part 70 to the first part 60.

If the first part 60 and the second part 70 have a smaller thickness at the connecting member 20 location, the body portion 22 deforms due to the slots 228, and as a result, a total length of the body portion 22 is decreased.

In addition, the connecting member 20 can absorb external shock to protect itself due to the slots 228.

It should be noted that the slots 228 may be defined in a middle portion of the body portion 22. Alternatively, the head portion 26 and the threads 225 may be omitted or replaced by other configurations.

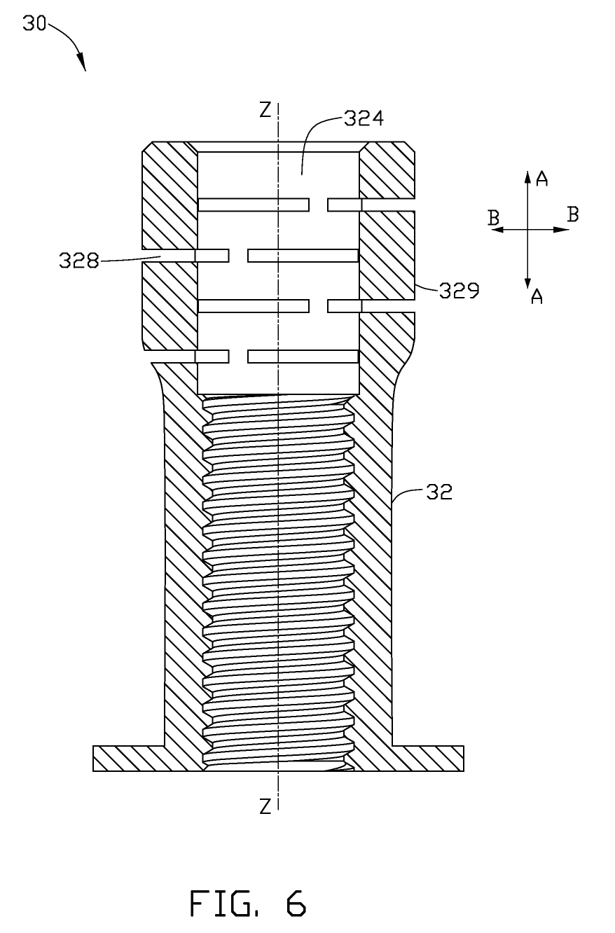

Referring to FIG. 6, a second embodiment of a connecting member 30 of the present disclosure is shown, differing from the connecting member 20 in the inclusion of an elongated and curved body portion 32. The body portion 32 defines a hole 324. A sidewall of the hole 324 defines a plurality of slots 328 communicating with the hole 324. A plurality of supporting portions 329 are formed as a result of the slots 328. Adjacent slots 328 are separated by one corresponding supporting portion 329.

Finally, while various embodiments have been described and illustrated, the embodiments are not to be construed as being limited thereto. Various modifications can be made to the embodiments by those skilled in the art without departing from the true spirit and scope of the embodiments as defined by the appended claims.

What is claimed is:

1. A connecting member comprising an elongated body portion defining a hole, wherein a sidewall of the hole defines a plurality of slots communicating with the hole; a plurality of supporting portions are formed between adjacent slots; at least one slot is above or below each supporting portion along a longitudinal axis of the body portion.

2. The connecting member of claim 1, wherein the slots are curved; centers of the curved slots coincide substantially with the longitudinal axis of the body portion; the slots extending substantially perpendicularly to the longitudinal axis of the body portion.

3. The connecting member of claim 2, wherein the body portion is substantially cylindrical; each three adjacent slots are distributed evenly along the same circumference of the body portion.

4. The connecting member of claim 1, further comprising a head portion formed on an end of the body portion away from the slots.

5. The connecting member of claim 4, wherein the head portion is substantially hexagonal.

6. The connecting member of claim 1, wherein a plurality of threads are defined in an inner surface of the hole of the body portion.

7. A connecting member comprising an elongated and curved body portion, the body portion defining a hole therein, wherein a sidewall of the hole defines a plurality of slots communicating with the hole; a plurality of supporting portions are formed between adjacent slots; at least one slot is above or below each supporting portion along a longitudinal axis of the body portion.

8. The connecting member of claim 7, wherein the slots are curved, centers of the curved slots coincide substantially with the longitudinal axis of the body portion; the slots extend substantially perpendicularly to the longitudinal axis of the body portion.

9. The connecting member of claim 8, wherein the body portion is substantially cylindrical; each three adjacent slots are evenly distributed along the same circumference of the body portion.

10. The connecting member of claim 7, further comprising a head portion on an end of the body portion away from the slots.

11. The connecting member of claim 10, wherein the head portion is substantially hexagonal.

12. The connecting member of claim 7, wherein a plurality of threads is defined in an inner surface of the hole of the body portion.
